(19) United States
(12) Patent Application Publication
(10) Pub. No.: US 2013/0037615 A1
(43) Pub. Date: Feb. 14, 2013

(54) Card Cover

(71) Applicants: Tara Powell, Calhoun Falls, SC (US); James Norman, JR., Calhoun Falls, SC (US)

(72) Inventors: Tara Powell, Calhoun Falls, SC (US); James Norman, JR., Calhoun Falls, SC (US)

(21) Appl. No.: 13/206,930

(22) Filed: Aug. 10, 2011

(51) Int. Cl. G06K 19/02; G06K 19/077

(52) U.S. Cl. 235/492; 235/487

(57) ABSTRACT

The object of the present invention is a set of stickers that encapsulates the account numbers on a credit card, debit card, gas card, or in general bank card to conceal the information for security purposes. The stickers, or guards, are designed to be tamper proof to ensure that no one else can be remove it, or if someone did, the owner would promptly realize and be able to take action. In addition to that, the device of the present invention includes a second circular sticker that is designed to encapsulate and protect the RFID chip on the card; thus, preventing it from being read while it is in the wallet, pocket, or purse.

### BACKGROUND OF THE INVENTION

1. Field of the Invention

The invention relates to card holding and protection devices.

2. Brief Description of the Prior Art

Various prior art patents and patents and patent applications are directed to resolve the question posed by the present information. For example, U.S. Published Patent Application No. 20090260731 to Roth and Roth discloses a smart card holder, or passport holder, that has two sides sealed together at three edges to leave an interior space dimensional and configured to hold a smart card or passport. Under the teachings of the Roth and Roth published patent application both sides have multiple layers; a first layer of dielectric material which substantially covers the entirety of both sides, a second layer of structural material to add strength, and a third layer of soft material which protects any magnetic strips on a card, or the like, from the dielectric material.

U.S. Pat. No. 6,845,863 to Riley discloses and claims a protective sleeve for the placement of credit cards, or other cards bearing magnetic strips and bar codes on rear surface of the cards, is presented to place such card into the protective sleeve to prevent damage to the bar code and the magnetic strip attached to the cards. Under the teaching of the Riley patent, the sleeve having a clear front portion for the visual identification of the front of the card, and a rear portion having a thin non-conductive metallic strip imbedded on the rear portion coinciding with the location of the magnetic strip on the card, and a smooth fabric portion coinciding with the location of the printed bar code on the card, the bar code and magnetic strip generally being provided on the rear surface of the card.

U.S. Pat. No. 5,941,375 to Kamens and Rosenberg discloses and claims a protective card case or sheath, for a single card having a magnetically encoded strip, is in the form of a generally rectangular, flat, sleeve-like holder. Under the teachings of the Kamens and Rosenberg, the claimed sheath has a protective strip along the top and bottom area of the front and rear panel for protection of the data encoded strip of a credit card or the like, regardless of the orientation of the card in the holder. The Kamens and Rosenburg card holder also includes a screened area or stripe along the top and bottom areas of the front and rear panels on which informational material can be printed. The card holding device is constructed by cutting and sealing dies to cut and seal inner and outer layers of clear polyvinylchloride; which are assembled and sealed to form front and rear panels; which are then sealed and assembled along three edges with one edge left open for insertion and removal of the encoded card. A third transparent panel may also be sealed around three sides over the rear panel to form a pocket for receiving an information bearing card.

U.S. Pat. No. 4,851,610 to LeBlanc and Hall discloses and claims a protective device for protecting the information on magnetically coded areas of plastic cards comprising strips of ferro-magnetic amorphous composition having a metal-glass characteristic situated adjacent covering the magnetically encoded areas on either side so as to redirect any corrupt electromagnetic and statomagnetic fields. In a preferred embodiment of the LeBlanc and Hall patent, the protective strips are incorporated in a card holding device.

U.S. Pat. No. 4,711,347 to Drexler and Haddock discloses and claims a protective envelope having an adhesive flap which lifts open to expose a data storage area of a data card, allowing data to be read while the card remains protected in the envelope. The flap may then be closed over and re-adhered to the card. Under the teachings of the Drexler and Haddock patent, the envelope comprises a base and a cover panel bonded at three edges to form a pocket for card storage. The cover panel is made up of a pair of fixed edge stripes bonded to respective opposite edges of the base, and a liftable flap back bonded to the back edges of the base. Envelope materials are preferably a transparent, flexible plastic; but only the flap need be flexible.

Despite all the efforts listed above, prior art patents and published patent applications describe structures that either are not truly convenient or else are not effective in resolving the problem addressed by the device of the current invention. Other devices have been advertised on various media but never patented or described into a printed publication.

### SUMMARY OF THE INVENTION

The device of the present invention consists of a sticker that covers the account numbers on a credit card, so as to conceal the information for security purposes. The sticker, or guard, is designed to be tamper proof to ensure that a third party cannot remove it without authorization of the owner of the card, and in case someone did, the owner would be able to detect the tamper and take action. In addition to that, the card protecting device of the present invention features a second sticker for encapsulating the Radio-frequency identification device, or RFID, thus preventing the card from being read by other radio-frequency devices.

It is then the principal object of the present invention to provide for a card protecting device to prevent credit card fraud. For example, if a person walks into a gas station and the attendant asks to hold the card while the person is gassing their car, for security purposes, the owner can cover the numbers of the card on both sides to prevent them being stolen, as well as block the RFID so that it cannot be scanned by those wishing to use its information.

It is a secondary objective of the present invention to provide for a practical consumer article that is effective in protecting privacy.

It is an additional objective of the present invention to provide a device that does not rust or deteriorate in the humid, high moist and hot conditions of a wallet.

It is a final objective of the present invention to provide a device that is cost efficient to build, but can eventually be sold at a premium.

These and other objectives achieve by the device of the present invention will be apparent by the drawings, by their detailed descriptions, and the specifications here from appended.

### BRIEF DESCRIPTION OF THE DRAWINGS

FIG. 1 is a perspective view of the first and second set of card protectors and all its features in accordance with the teachings of the present invention;

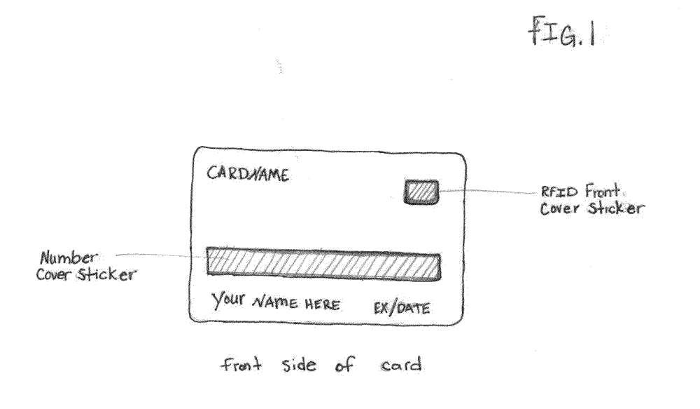

FIG. 2 is a perspective view of the back of the first and second set of card protector guards of FIG. 1

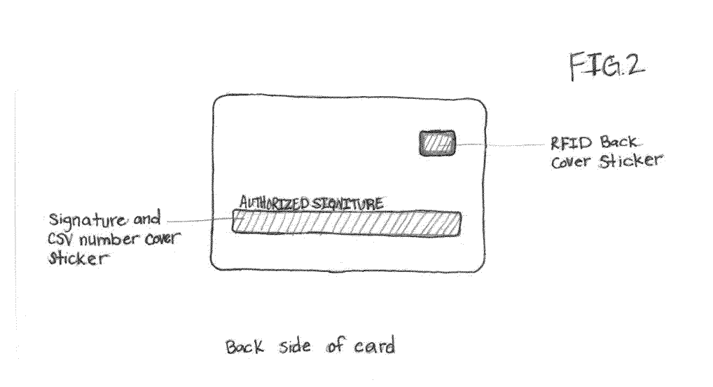

FIG. 3 is a perspective view of the third set of card protector guards of FIG. 1

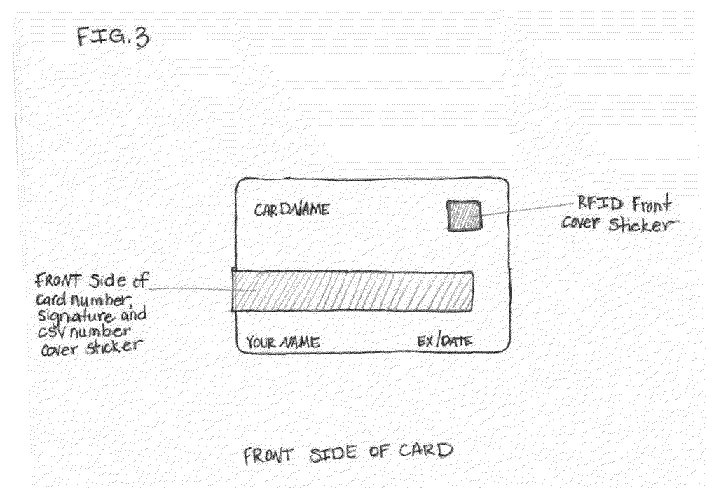

FIG. 4 is a perspective view of the third set of card protector guards of FIG. 1

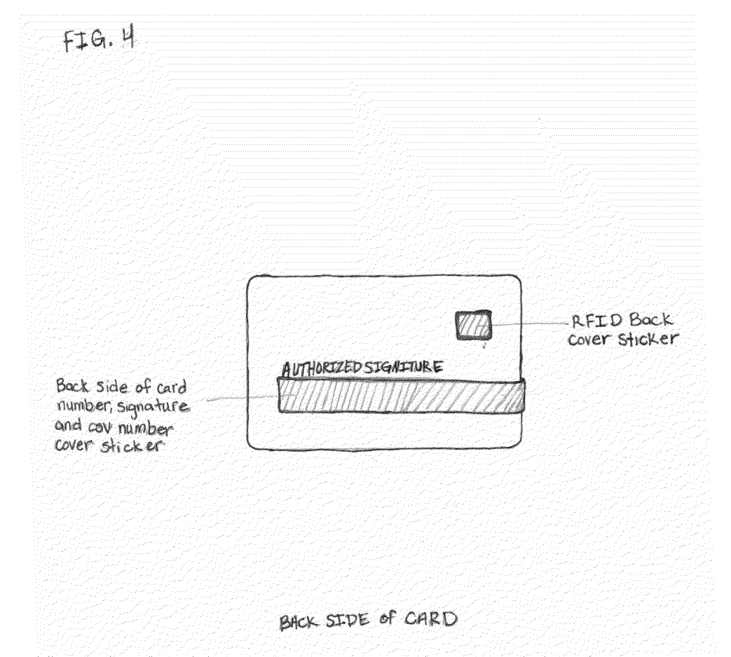

FIG. 5 is a perspective view of card protector guards of FIG. 1.

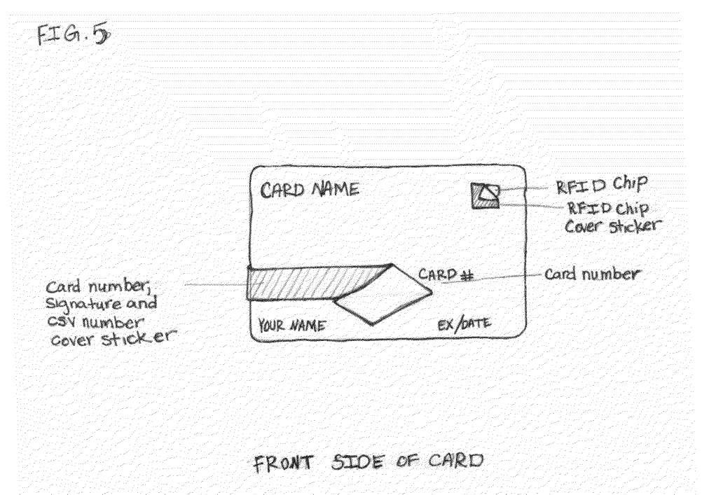

### DESCRIPTION OF THE PREFERRED EMBODIMENT

As shown and illustrated in the drawings, the device of the present invention's concept is multiple sets of stickers that encapsulate the account numbers on a credit card, so as to conceal this information for security purposes. The sticker, or guard, is designed to be tamper proof to ensure that no one can remove it without the express consent of the owner. Additionally, a second sticker is associated with the device for encapsulating and protecting the information of the RFID, thus preventing the information from being read and stolen in a wallet, pocket, or purse. Additionally, a third sticker is associated to allow the user the choice of either set to protect the card numbers on a credit card.

The inventor refers to the device of the present invention as the “On Guard”. As currently designed the device provides a simple, yet effective, security feature for a credit card to conceal the account numbers, maintaining the privacy of the owner. The guard band is removable by the owner, yet reveals when someone else has tampered or attempted to tamper with it. These guards are designed in such a way that once removed they cannot be reaffixed to the card.

The device of the present invention as currently designed, consisting of the guard strip made from light durable metallic and adhesive material that would bend around the perimeter, or placed on either side, of the card, thus concealing the account numbers. Considering that someone attempting to breach the card would simply remove the guard and replace it, a tamper proof security feature has been considered to prevent this. This method entails using a thin and very slick material that would have a one-time use adhesive on the underside (facing the card).

Moreover, the card protector of the present invention has an air sensitive material layered above the adhesive. Therefore, if the guard is removed and the material touches air the material would change colors allowing the user to detect that they card had been compromised. This material has a clear covering allowing the material to be protected from air on top of the card, and allowing the user to see the change in color should the card be tampered with.

The device of the present invention as currently designed, also consists of a smaller sticker that would be place above the RFID chip placed within the credit card or the like. This sticker consisting of a layer of one-time use adhesive, a layer of metallic material to reflect other radio-frequencies, a layer of air sensitive material that will change colors if sticker is removed and a clear slick layer to allow the sticker to stay on the card while being swiped.

The current invention consists of two stickers, one that would wrap around and encase the card numbers, and another set that would cover both sides of the RFID chip placed inside the card. If either set of stickers are removed the owner would immediately be able to detect the removal and contact authorities to handle the compromised card.

Manufacture materials include simple components already on the market and/or readily available such as tough, durable rubber, wood, cardboard, plastic, fabric, paper, or other materials.

As to further discussion of the manner of usage and operation of the present invention, the same should be apparent from the above description. Accordingly, no further discussion relating to the manner of usage and operation will be provided.

With respect to the above mentioned description, it is to be realized that the optimum dimensional relationships for the parts of the invention, to include variations in size, materials, shape, forms, function, and manner of operation, assembly and users are deemed readily apparent and obvious to one skilled in the art and all equivalent relationships to those illustrated in the drawings described in the specifications are intended to be encompasses by the present invention.

Therefore, the foregoing is considered an illustrative of the principle of the invention. Further, since numerous modifications and changes will readily occur to those skilled in the art it is not desired to limit the invention to the exact construction and operation shown and described, and accordingly, all suitable modifications and equivalents may be resorted to falling within the scope of the invention.

I claim:

1. A security device consisting:
a. At least three sets of stickers

2. The security device of claim 1 wherein said sets of stickers at least one has an elongated shape at least the length of the standard credit card and at least one has an elongated shape at least twice the length of the standard credit card and at least one has a circular shape, whereby said sticker provides means for user to conceal private information.

3. The security device of claim 2 wherein said stickers consisting a metal substance, whereby the Radio-Frequency Identification Device cannot transmit to unauthorized sources.

4. The security device of claim 2 wherein said stickers consisting a one-time adhesive backing, whereby said user can only apply the sticker at one time, allowing said user to identify if there has been a security breach.

5. The security device of claim 2 wherein said sticker consisting a substance that when touching the air changes color, whereby said user can identify if the sticker has been breached.

6. The security device of claim 2, wherein said stickers consisting of a layer of thin, slick material, whereby said user can fit card into appropriate sliding devices.
